(19) United States
(12) Patent Application Publication
(10) Pub. No.: US 2010/0218019 A1
(43) Pub. Date: Aug. 26, 2010

(54) NON-RECURSIVE ADAPTIVE FILTER FOR PREDICTING THE MEAN PROCESSING PERFORMANCE OF A COMPLEX SYSTEM'S PROCESSING CORE

(75) Inventor: Walters Eckhard, Plan-Les-Ouates (CH)

Correspondence Address: SEED INTELLECTUAL PROPERTY LAW GROUP PLLC, 701 FIFTH AVENUE, SUITE 5400, SEATTLE, WA, 98104-7092, US

(73) Assignee: ST-ERICSSON SA, Plan-Les-Ouates (CH)

(21) Appl. No.: 12/757,783

(22) Filed: Apr. 9, 2010

Related U.S. Application Data
(63) Continuation-in-part of application No. PCT/IB2008/053931, filed on Sep. 26, 2008.

(30) Foreign Application Priority Data
Oct. 9, 2007 (EP) 07118073.1

(51) Int. Cl. G06F 1/00

(52) U.S. Cl. 713/322; 713/300

(57) ABSTRACT

A power management unit and a corresponding method for controlling performance and power consumption of a complex low-power integrated system's processing core by automatically reducing them to a level where outstanding computational operations and software tasks can be performed just in time for further processing. A linear non-recursive adaptive filter performs a processor load prediction of the system's processing core is applied, whose filter coefficients may e.g., be calculated based on the least mean square (LMS) optimization criterion or based on any other similarity measure. In this connection, the adaptive filter may e.g., be used to predict the regularity of the clock frequency in the processing core. By using this information, the linear non-recursive adaptive filter predicts the duration of how long the processing core may lower its operating voltage to still be able to complete all its tasks in time.

### BACKGROUND

1. Technical Field

The present disclosure proposes a method, system and article for minimizing the power consumption of a complex low-power integrated system's processing core.

2. Description of the Related Art

There has been tremendous progress in semiconductor technology since the first ICs were introduced in the 1960's. Minimum feature sizes, i.e., minimum dimensions of integrated semiconductor structures, have become much smaller, and die sizes have increased. Consequences of this technology scaling trend are reduced device capacitances, higher integration densities, performance improvements and increased circuit complexities. Whereas circuit performance and the chip area were the major issues in IC design in the past, power consumption is now another major design criterion. This development has been driven mainly by the rapid growth of the portable consumer electronics market, where system running time, battery weight, and battery volume are critical parameters. The aforementioned increase in integration density and circuit performance, however, has led to enormous on-chip power and power densities. Since excessive total power and power density cause serious reliability problems, power consumption is no longer a specific problem of mobile applications. In fact, it is equally critical, if not more, in the design of high-performance ICs for non-battery-powered applications.

Throughout the last ten years, numerous approaches to low power design have been proposed. These include both software and hardware optimization strategies. Aside from regulation circuitries supporting advanced voltage scaling and architecture-driven voltage scaling strategies based on process parallelization and pipelining, system-based power management techniques are frequently employed.

Power management reduces the amount of energy wasted whenever parts of a system are not needed at all or not at full speed. With power management schemes the functionality and the performance of a system or circuit are adjusted to time-variant requirements. Examples of such methods are power supply shutdown, dynamic power management, clock gating, and adaptive supply voltage scaling.

In a simple embodiment of power management, a system component, e.g., a particular chip, is completely separated from the power supply via an external controllable regulator during idle periods. This is an effective way of avoiding unnecessary static and dynamic power dissipation in inactive components that does not complicate the design of the component to be shut down. A power manager unit (PMU) that controls the regulator is completely external, and the power supply pins are the only required interface to the power-managed component. Thus, the component can be designed in the traditional way without the need for any special power management support to be implemented. Major drawbacks of this power supply shutdown approach are the following. Firstly, there is a large power-on delay, which is the time it takes for the supply voltage to stabilize after being switched on again. Secondly, registers and other non-permanent memory cells lose their content.

A power supply shutdown can, in principle, be applied to blocks within an integrated circuit instead of to the entire chip. This, however, requires the power supply infrastructure on the chip to be modified such that the power supply nets of different blocks are separated from each other and made accessible from the exterior via separate pins. As a consequence, power supply shutdown is restricted to chips in their entirety or to a small number of large blocks on a chip.

### BRIEF SUMMARY

The present disclosure proposes a method for minimizing the power consumption of a complex low-power integrated system's processing core and a non-recursive adaptive filter that is adapted to perform a processor load prediction of a complex system's processing core so as to minimize its processing clock frequency and thus being able to reduce power consumption of the entire processing subsystem. Thereby, a power-efficient filter implementation is provided for running the adaptive filter on a digital signal processor.

Although there are means to estimate a complex system's processing performance (in million instructions per second, MIPS) for the next time slot by monitoring an open operating system scheduler queue, not every processing core has an open operating system installed on it. It may thus be an object of an embodiment to provide a suitable measure for predicting clock frequency f_{c} without requiring knowledge of the software load scheduled in the operating system. Moreover, prediction during runtime is desirable as the software may be too complex to predict performance requirements during design time.

Typically, a software application has some sort of a main program, a RISC OS Toolkit (RTK)—a class library for developing RISC OS application programs in C++, which differs from other such libraries currently available for RISC OS in its support for automatic layout by specifying the relationship between different visual components (for example, the fact that they are arranged in a grid or a column), thus eliminating the need for a template editor and allowing a layout to change at runtime to accommodate varying content—or at least a simple scheduler that calls tasks and detects idle states, where then the processor clock can be stalled to save power. But as mentioned below, from power perspective it is more efficient to reduce clock frequency f_{c} to just accomplish tasks just in time rather than run and sleep.

An embodiment of the present disclosure is dedicated to a power management unit and a method for minimizing the power consumption of a complex low-power integrated system's processing core. Thereby, an adaptive filter is used to predict the regularity of the clock frequency in the processing core. By using this information, the adaptive filter predicts the duration of how long the processing core may lower its operating voltage to still be able to complete all its tasks in time. A power-efficient filter implementation is provided for running the adaptive filter on a digital signal processor.

As mentioned below, a plurality of battery- and non-battery-powered applications and devices comprise suitable power management tools to manage the idle times of their processing cores. Furthermore, there is usually a time basis in each information processing system. So the time where the system is allowed to sleep can be measured. In this connection, an embodiment of the present disclosure is dedicated to a suitable means for predicting clock frequency requirements by monitoring the sleep time ratio in a sliding observation window representing a time frame of N subsequent time slices, thereby using a non-recursive filtering model realized by an adaptive finite impulse response filter to execute a look-ahead prediction. As there is typically some periodic behavior to be expected in a software processing profile, a finite impulse response filter can be used to detect this regularity by means of adaptive filter coefficients which are updated after the prediction for each one of a given set of subsequent time slices within a sliding observation window. For example, an algorithm which is based on the least mean square (LMS) optimization criterion can be applied to minimize sleep duration by stretching the clock periods in the particular time slices to their maximum tolerable.

To be more precise, a first exemplary embodiment of the present disclosure relates to a power management unit for controlling the performance and power consumption of a complex low-power integrated system's processing core by automatically reducing them to a certain level where outstanding computational operations and software tasks can be performed just in time for further processing. The power management unit may be implemented as an instance comprising or having access to an adaptive prediction filter which predicts the regularity of the processing core's clock frequency f_{c} without requiring information about a scheduled processing load. According to an embodiment of the present disclosure, this is accomplished by monitoring the sleep time ratio in said sliding observation window and executing a look-ahead prediction.

The adaptive prediction filter mentioned above may e.g., be realized as a linear finite impulse response filter with (N+1) filter coefficients, wherein said filter provides amplification, summation and delay elements for calculating a predicted clock frequency f_{c}ⁿ⁺¹ at a time slice (n+1) directly succeeding a current time slice n within said sliding observation window as a weighted average of measured clock frequencies f_{c}ⁿ, f_{c}ⁿ⁻¹, f_{c}ⁿ⁻², . . . , f_{c}^{n-N} at a number of time slices (n, n−1, n−2, . . . , n−N) preceding said time slice (n+1), thereby using real-valued weighting coefficients {αₖ|k=0, 1, 2, . . . , N} which are adapted to minimize the clock frequency prediction error.

The adaptive prediction filter may e.g., be implemented by a digital signal processor which is adapted to calculate the minimized frequency prediction error and thus to calculate a minimized sleep duration of the processing core by applying a certain similarity measure, wherein the latter may e.g., be given by the least mean square optimization criterion.

According to an embodiment, the aforementioned complex low-power integrated system may e.g., be given by a high-end cellular mobile terminal, a workstation, a notebook, a laptop, an organizer, a personal digital assistant (PDA), a pocket calculator or any other wireless or wire-bound, battery- or means-powered computing, communication and/or information processing device.

A second example embodiment of the present disclosure relates to a method for controlling the performance and power consumption of a complex low-power integrated system's processing core by automatically reducing them to a level where outstanding computational operations and software tasks can be performed just in time for further processing. Thereby, an adaptive prediction filtering algorithm for predicting the regularity of the processing core's clock frequency f_{c} without requiring information about a scheduled processing load is applied which executes a look-ahead prediction while the sleep time ratio is monitored in a sliding observation window for N subsequent time slices.

The adaptive prediction filtering algorithm mentioned above may e.g., be based upon a filtering model using a linear finite impulse response filter with (N+1) filter coefficients, wherein the adaptive prediction filtering algorithm may provide amplification, summation and delay operations for calculating a predicted clock frequency f_{c}ⁿ⁺¹ at a time slice (n+1) directly succeeding a current time slice n within said sliding observation window as a weighted average of measured clock frequencies f_{c}ⁿ, f_{c}ⁿ⁻¹, f_{c}ⁿ⁻², . . . , f_{c}^{n-N} at a given number of time slices (n, n−1, n−2, . . . , 1) preceding said time slice (n+1), thereby using real-valued weighting coefficients {αₖ|k=0, 1, . . . , N} which are adapted to minimize the clock frequency prediction error.

Said method may e.g., comprise the step of calculating the minimized frequency prediction error and thus calculating a minimized sleep duration of the processing core by applying a similarity measure, wherein the latter may e.g., be given by the least mean square optimization criterion.

According to a third and a fourth example embodiment, the present disclosure further refers to a complex low-power integrated system comprising a power management unit as described above and to a software program product for executing the above-described method when being installed and running on the system, respectively.

In an embodiment, a power management unit for controlling the performance and power consumption of a complex low-power integrated system's processing core by automatically reducing them to a level where outstanding computational operations and software tasks can be performed just in time for further processing, comprises or has access to an adaptive prediction filter for predicting the regularity of the processing core's clock frequency (f_{c}) without requiring information about a scheduled processing load by executing a look-ahead prediction based on the processing core's sleep time ratio, the latter being monitored in a sliding observation window for N subsequent time slices. In an embodiment, said adaptive prediction filter is realized as a linear finite impulse response filter with (N+1) filter coefficients. In an embodiment, the adaptive prediction filter provides amplification, summation and delay elements for calculating a predicted clock frequency (f_{c}ⁿ⁺¹) at a time slice (n+1) succeeding a current time slice (n) within said sliding observation window as a weighted average of measured clock frequencies (f_{c}ⁿ, f_{c}ⁿ⁻¹, f_{c}ⁿ⁻², . . . , f_{c}^{n-N}) at time slices (n, n−1, n−2, . . . , n−N) preceding said time slice (n+1), thereby using real-valued weighting coefficients {aₖ|k=0, 1, 2, . . . , N} which are adapted to minimize the clock frequency prediction error. In an embodiment, the power management unit comprises a digital signal processor which implements said adaptive prediction filter, said digital signal processor being adapted to calculate the minimized frequency prediction error and thus to calculate a minimized sleep duration of the processing core by applying a similarity measure. In an embodiment, said similarity measure is given by the least mean square optimization criterion. In an embodiment, said complex low-power integrated system is a high-end cellular mobile terminal, a workstation, a notebook, a laptop, an organizer, a personal digital assistant, a pocket calculator or any other wireless or wire-bound, battery- or means-powered computing, communication and/or information processing device.

In an embodiment, a complex low-power integrated system comprises a power management unit for controlling the performance and power consumption of the system's processing core by automatically reducing them to a level where outstanding computational operations and software tasks can be performed just in time for further processing, said power management unit comprising or having access to an adaptive prediction filter for predicting the regularity of the processing core's clock frequency (f_{c}) without requiring information about a scheduled processing load by executing a look-ahead prediction based on the processing core's sleep time ratio, the latter being monitored in a sliding observation window for N subsequent time slices. In an embodiment, said adaptive prediction filter is realized as a linear finite impulse response filter with (N+1) filter coefficients. In an embodiment, the adaptive prediction filter provides amplification, summation and delay elements for calculating a predicted clock frequency (f_{c}ⁿ⁺¹) at a time slice (n+1) succeeding a current time slice (n) within said sliding observation window as a weighted average of measured clock frequencies (f_{c}ⁿ, f_{c}ⁿ⁻¹, f_{c}ⁿ⁻², . . . , f_{c}^{n-N1}) at time slices (n, n−1, n−2, . . . , n−N) preceding said time slice (n+1), thereby using real-valued weighting coefficients {aₖ|k=0, 1, 2, . . . , N} which are adapted to minimize the clock frequency prediction error. In an embodiment, the complex low-power integrated system comprises a digital signal processor which implements said adaptive prediction filter, said digital signal processor being adapted to calculate the minimized frequency prediction error and thus to calculate a minimized sleep duration of the processing core by applying a similarity measure. In an embodiment, said similarity measure is given by the least mean square optimization criterion.

In an embodiment, a method for controlling the performance and power consumption of a complex low-power integrated system's processing core by automatically reducing them to a level where outstanding computational operations and software tasks can be performed just in time for further processing, wherein an adaptive prediction filtering algorithm for predicting (S2) the regularity of the processing core's clock frequency (f_{c}) without requiring information about a scheduled processing load is applied which executes a look-ahead prediction while the sleep time ratio is monitored (S1) in a sliding observation window for N subsequent time slices. In an embodiment, said adaptive prediction filtering algorithm is based upon a filtering model using a linear finite impulse response filter with (N+1) filter coefficients. In an embodiment, the adaptive prediction filtering algorithm provides amplification, summation and delay operations for calculating a predicted clock frequency (f_{c}ⁿ⁺¹) at a time slice (n+1) directly succeeding a current time slice (n) within said sliding observation window as a weighted average of measured clock frequencies (f_{c}ⁿ, f_{c}ⁿ⁻¹, f_{c}ⁿ⁻², . . . , f_{c}^{n-N1}) at time slices (n, n−1, n−2, . . . , n−N) preceding said time slice (n+1), thereby using real-valued weighting coefficients {aₖ|k=0, 1, 2, . . . , N} which are adapted to minimize the clock frequency prediction error. In an embodiment, the method comprises the step of calculating the minimized frequency prediction error and thus calculating a minimized sleep duration of the processing core by applying a similarity measure. In an embodiment, said similarity measure is given by the least mean square optimization criterion.

In an embodiment, a software program product's contents causes a processor to control the performance and power consumption of a complex low-power integrated system's processing core by automatically reducing them to a level where outstanding computational operations and software tasks can be performed just in time for further processing when being installed and running on the system, wherein an adaptive prediction filtering algorithm for predicting (S2) the regularity of the processing core's clock frequency (f_{c}) without requiring information about a scheduled processing load is applied which executes a look-ahead prediction while the sleep time ratio is monitored (S1) in a sliding observation window for N subsequent time slices. In an embodiment, said adaptive prediction filtering algorithm is based upon a filtering model using a linear finite impulse response filter with (N+1) filter coefficients. In an embodiment, the adaptive prediction filtering algorithm provides amplification, summation and delay operations for calculating a predicted clock frequency (f_{c}ⁿ⁺¹) at a time slice (n+1) directly succeeding a current time slice (n) within said sliding observation window as a weighted average of measured clock frequencies (f_{c}ⁿ, f_{c}ⁿ⁻¹, f_{c}ⁿ⁻², . . . , f_{c}^{n-N}) at time slices (n, n−1, n−2, . . . , n−N) preceding said time slice (n+1), thereby using real-valued weighting coefficients {aₖ|k=0, 1, 2, . . . , N} which are adapted to minimize the clock frequency prediction error. In an embodiment, the controlling comprises the step of calculating the minimized frequency prediction error and thus calculating a minimized sleep duration of the processing core by applying a similarity measure. In an embodiment, said similarity measure is given by the least mean square optimization criterion.

In an embodiment, a power management unit comprises: an input configured to receive a signal predictive of a regularity of a system processing core clock frequency based on a processing core sleep time ratio in a sliding observation window; and a controller configured to generate signals to control processing core performance and power consumption based on the signal indicative of the regularity of the system processing core clock frequency. In an embodiment, the controller is configured to generate the signals to control processing core performance and power consumption to reduce performance and power consumption to levels consistent with a prediction of levels to perform outstanding computational operations and software tasks just in time for further processing. In an embodiment, the controller is configured to generate the signals to control processing core performance and power consumption without using information regarding a scheduled processing load. In an embodiment, the power management unit further comprises an adaptive prediction filter coupled to the input and configured to generate the signal predictive of a regularity of a processing core clock frequency. In an embodiment, the sliding observation window comprises a number N of time slices and the adaptive prediction filter comprises a linear finite impulse response filter with (N+1) filter coefficients. In an embodiment, the power management unit further comprises an adaptive prediction filter coupled to the input and configured to provide amplification, summation and delay elements to calculate a predicted clock frequency (f_{c}ⁿ⁺¹) at a time slice (n+1) succeeding a current time slice (n) within said sliding observation window as a weighted average of measured clock frequencies (f_{c}ⁿ, f_{c}ⁿ⁻¹, f_{c}ⁿ⁻², . . . , f_{c}^{n-N}) at time slices (n, n−1, n−2, . . . , n−N) preceding said time slice (n+1), thereby using real-valued weighting coefficients {aₖ|k=0, 1, 2, . . . , N} which are adapted to minimize a clock frequency prediction error. In an embodiment, the power management unit comprises a digital signal processor which implements said adaptive prediction filter, said digital signal processor being adapted to calculate a minimized frequency prediction error and thus to calculate a minimized sleep duration of the processing core by applying a similarity measure. In an embodiment, said similarity measure is given by a least mean square optimization criterion.

In an embodiment, the system is a complex low-power integrated system. In an embodiment, the system is at least one of a high-end cellular mobile terminal, a workstation, a notebook, a laptop, an organizer, a personal digital assistant, and a pocket calculator. In an embodiment, a complex low-power integrated system, comprises: a processing core; and a power management unit configured to generate signals to control performance and power consumption of the processing core based on an indication of a processing core sleep time ratio in a sliding observation window having a number N of time slices. In an embodiment, the complex low-power integrated system further comprises an adaptive prediction filter configured to generate a signal predictive of a regularity of the processing core clock frequency based on the indication of the processing core sleep time ratio, wherein the power management unit is configured to generate the signals to control performance and power consumption based on the signal predictive of the regularity of the processing core clock frequency. In an embodiment, the adaptive prediction filter comprises a linear finite impulse response filter with (N+1) filter coefficients. In an embodiment, the adaptive prediction filter comprises amplification, summation and delay elements configured to calculate a predicted clock frequency (f_{c}ⁿ⁺¹) at a time slice (n+1) succeeding a current time slice (n) within said sliding observation window as a weighted average of measured clock frequencies (f_{c}ⁿ, f_{c}ⁿ⁻¹, f_{c}ⁿ⁻², . . . , f_{c}^{n-N1}) at time slices (n, n−1, n−2, . . . , n−N) preceding said time slice (n+1), thereby using real-valued weighting coefficients {aₖ|k=0, 1, 2, . . . , N} which are adapted to minimize a clock frequency prediction error. In an embodiment, the complex low-power integrated system comprises a digital signal processor which implements said adaptive prediction filter, said digital signal processor being configured to calculate a minimized frequency prediction error and a minimized sleep duration of the processing core by applying a similarity measure. In an embodiment, said similarity measure is given by a least mean square optimization criterion.

In an embodiment, a method comprises: monitoring a sleep time ratio of a processing core in a sliding observation window having a number N of time slices; predicting a regularity of a processing core clock frequency based on the monitoring; and generating signals to control processing core performance and power consumption based on the predicting. In an embodiment, the predicting comprises applying an adaptive prediction filtering algorithm based upon a filtering model using a linear finite impulse response filter with (N+1) filter coefficients. In an embodiment, the adaptive prediction filtering algorithm comprises using amplification, summation and delay operations to calculate a predicted clock frequency (f_{c}ⁿ⁺¹) at a time slice (n+1) succeeding a current time slice (n) within said sliding observation window as a weighted average of measured clock frequencies (f_{c}ⁿ, f_{c/n-1}, f_{c}ⁿ⁻², . . . , f_{c}^{n-N1}) at time slices (n, n−1, n−2, . . . n−N) preceding said time slice (n+1), thereby using real-valued weighting coefficients {aₖ|k=0, 1, 2, . . . , N} which are adapted to minimize a clock frequency prediction error. In an embodiment, the method comprises calculating a minimized frequency prediction error and thus calculating a minimized sleep duration of the processing core by applying a similarity measure. In an embodiment, said similarity measure is given by a least mean square optimization criterion.

In an embodiment, a computer readable memory medium's contents cause at least one processor to perform a method, the method comprising: monitoring a sleep time ratio of a processing core in a sliding observation window having a number N of time slices; predicting a regularity of a processing core clock frequency based on the monitoring; and generating signals to control processing core performance and power consumption based on the predicting. In an embodiment, the predicting comprises applying an adaptive prediction filtering algorithm based upon a filtering model using a linear finite impulse response filter with (N+1) filter coefficients. In an embodiment, the adaptive prediction filtering algorithm provides amplification, summation and delay operations to calculate a predicted clock frequency (f_{c}ⁿ⁺¹) at a time slice (n+1) succeeding a current time slice (n) within said sliding observation window as a weighted average of measured clock frequencies (f_{c}ⁿ, f_{c}ⁿ⁻¹, f_{c}ⁿ⁻², . . . , f_{c}^{n-N}) at time slices (n, n−1, n−2, . . . , n−N) preceding said time slice (n+1), thereby using real-valued weighting coefficients {aₖ|k=0, 1, 2, . . . , N} which are adapted to minimize a clock frequency prediction error. In an embodiment, the method comprises calculating a minimized frequency prediction error and thus calculating a minimized sleep duration of the processing core by applying a similarity measure. In an embodiment, said similarity measure is given by a least mean square optimization criterion.

In an embodiment, a power management unit comprises: means for monitoring a sleep time ratio of a processing core in a sliding observation window having a number N of time slices; means for predicting a regularity of a processing core clock frequency based on the monitoring; and means for generating signals to control processing core performance and power consumption based on the predicting. In an embodiment, the means for predicting comprises a linear finite impulse response filter with (N+1) filter coefficients. In an embodiment, the means for predicting is configured to use amplification, summation and delay operations to calculate a predicted clock frequency (f_{c}ⁿ⁺¹) at a time slice (n+1) succeeding a current time slice (n) within said sliding observation window as a weighted average of measured clock frequencies (f_{c}ⁿ, f_{c}ⁿ⁻¹, f_{c}ⁿ⁻², . . . , f_{c}^{n-N1}) at time slices (n, n−1, n−2, . . . , n−N) preceding said time slice (n+1), thereby using real-valued weighting coefficients {aₖ|k=0, 1, 2, . . . , N} which are adapted to minimize a clock frequency prediction error. In an embodiment, the means for generating signals to control processing core performance and power consumption is configured to calculate a minimized sleep duration of the processing core by applying a similarity measure. In an embodiment, said similarity measure is given by a least mean square optimization criterion.

### BRIEF DESCRIPTION OF THE SEVERAL VIEWS OF THE DRAWINGS

Examples of advantageous features, aspects, and advantages of various embodiments will become evident from the following description, the appended claims and the accompanying drawings. Thereby,

FIG. 1 shows a block diagram of a computer system using a power management unit as known from the prior art,

FIG. 2 shows a schematic block diagram of a linear non-recursive adaptive prediction filter used by the proposed power management unit according to an embodiment, and

FIG. 3 shows a flowchart that illustrates the proposed method according to an embodiment.

### DETAILED DESCRIPTION

In the following, embodiments of a power management unit and method will be explained in more detail with respect to special refinements and referring to the accompanying drawings and in comparison to the prior art. It should be understood, however, that the drawings and detailed description thereto are not intended to limit the disclosure to the particular form disclosed, but, on the contrary, the disclosure is to cover all modifications, equivalents and alternatives falling within the spirit and scope of the present disclosure.

In the following description, numerous specific details are given to provide a thorough understanding of embodiments. The embodiments can be practiced without one or more of the specific details, or with other methods, components, materials, etc. In other instances, well-known structures, materials, or operations, such as, for example, decoders, processor cores, adaptive filters and delay elements are not shown or described in detail to avoid obscuring aspects of the embodiments.

Reference throughout this specification to “one embodiment” or “an embodiment” means that a particular feature, structure, or characteristic described in connection with the embodiment is included in at least one embodiment. Thus, the appearances of the phrases “in one embodiment” “according to an embodiment” or “in an embodiment” and similar phrases in various places throughout this specification are not necessarily all referring to the same embodiment. Furthermore, the particular features, structures, or characteristics may be combined in any suitable manner in one or more embodiments.

The headings provided herein are for convenience only and do not interpret the scope or meaning of the embodiments.

For better understanding the principles of an efficient power management, a brief description of how dynamic power consumption P_{dyn} of conventional CMOS-based low-power integrated semiconductor circuitries can be estimated and controlled will now be given. In digital CMOS circuits, which are used in the majority of microprocessors, power consumption can be modeled quite accurately by simple equations. CMOS circuits have both dynamic and static power consumption. Whereas static power consumption caused by bias and leakage currents usually remains under 1 mW, the dynamic component is the dominant source of power consumption for most of the CMOS microprocessors which are available on the market. Every transition of a digital circuit consumes power, because every charge and subsequent discharge of the digital circuit's capacitance results in a dissipation in the circuit's resistive components. As described in the article “Processor design for portable systems” (Journal of VLSI Signal Processing, August 1996) by T. Burd and R. Brodersen, dynamic power consumption of a CMOS microprocessor can be estimated by

$${P}_{d yn} = {\sum }_{m = 1}^{M} {C}_{m} \cdot {f}_{m} \cdot {U}_{DD}^{2} [ W ] , \qquad ( 1 )$$

where M denotes the total number of gates in the circuit, Cₘ the load capacitance of gate gₘ, fₘ the specific switching frequency of gate gₘ (with mε{1, 2, . . . , M}), and U_{DD} the circuit's supply voltage. It follows from equation (1) that a reduction of U_{DD} is the most effective way to lower dynamic power consumption P_{dyn}. Lowering U_{DD}, however, creates the problem of increased circuit delay. An estimation of this circuit delay is given by

$$τ ∝ \frac{{U}_{DD}}{{( {U}_{G} - {U}_{T} )}^{2}} , \qquad ( 2 )$$

where τ [ns] is the propagation delay of the CMOS transistor, U_{T} [V] the threshold voltage, and U_{G} the input gate voltage. This propagation delay restricts the clock frequency f_{c} in a microprocessor. From equations (1) and (2) it follows that there is a fundamental tradeoff between switching speed and supply voltage. Processors can operate at a lower supply voltage, but only if clock frequency f_{c} is reduced correspondingly to tolerate the increased propagation delay τ. When assuming that dynamic power P_{dyn} is dominant and that gates gₘ of the microprocessor form a collective switching capacitance Cₛ with a common clock frequency f_{c}, it can be obtained that

P_{dyn}=Cₛ·f_{c}·U_{DD}²[W]. (3)

Equation (3) shows that a clock frequency reduction linearly decreases power, and that voltage reduction results in a quadratic power reduction. The critical path of a microprocessor is the longest path a signal must travel in a clock cycle T_{c}=1/f_{c}. The implicit constraint is that the propagation delay τ of the critical path must be smaller than T_{c}. In fact, the microprocessor ceases to function when U_{DD} is lowered and propagation delay τ becomes too large to satisfy internal timings at clock frequency f_{c} (see equation (2)). For a given clock frequency f_{c}, voltage scaling is then the mechanism to minimize power consumption.

Complex low-power integrated electronic systems, such as e.g., high-end cellular mobile terminals, personal computers, workstations, notebooks, laptops, organizers, personal digital assistants, pocket calculators and other wireless or wire-bound, battery- or means-powered computing, communication and/or information processing devices, often apply advanced dynamic power management (DPM) schemes. Such systems contain various power-manageable components (PMC) controlled by a PMU. Each PMC provides a number of high performance, low power and sleep modes/states. The PMU, which may either be implemented in hardware or in software, continuously observes the system and puts the PMCs in appropriate states according to the actual requirements at certain points in time.

Dynamic power management is widely used in modem notebook computers and, hence, special notebook processors are designed as PMCs. The instruction set, the clock network, the interrupts, etc. are adapted to the requirements of dynamic power management. Most processors support different low power and sleep modes. In some modes, idle modules within the processors are not separated from the power supply as in the power supply shutdown approach. Instead, the respective parts of the clock network are switched off. If all inputs of the modules to be switched off are registered, there is absolutely no switching activity and, hence, no dynamic power dissipation in the idle modules. This technique is called global clock gating. In other modes, certain modules are actually separated from the power supply via internal switches in the power supply nets. Finally, for modules which are not completely idle but also not fully utilized, the clock frequency or the supply voltage or both may be momentarily reduced.

Although designing a PMC requires a significant amount of additional design effort, the most challenging task is the development of an effective power management policy (PMP) and its implementation as PMU firm- or software. This software should know about the power characteristics of all modules and be aware of the inevitable performance degradation and power overhead associated with going to and returning from different low power and sleep modes. An effective PMP should reliably predict the idle time of a module and accurately calculate the net power reduction.

The Advanced Power Management (APM) specification was the first industry standard in the field of DPM and has only recently been replaced by the more powerful Advanced Configuration and Power Interface (ACPI).

Local clock gating is another popular power management technique that requires only moderate additional design effort. It is frequently used in digital signal processors (DSPs), application specific processors, embedded processors and the like, but can be applied to practically any type of circuit. With local clock gating, the control signals that are used to deactivate certain parts of the clock network are locally generated in hardware. In principle, arbitrarily small sub-circuits can be deactivated in this way. Since power management based on local clock gating is rather an architectural-level than a high-level technique.

A relatively new power management approach is adaptive supply voltage scaling. This is a very attractive technique for dynamic power optimization if the requirements on the performance of a chip vary continuously over time. Instead of just switching off idle components of a system or idle modules on a chip, the clock frequency and the supply voltage are continuously adjusted to the instantaneous performance demand.

As mentioned above, a complex system, such as e.g., a high-end cellular mobile phone, typically employs measures to minimize power consumption of its major power supplied circuit elements. In the digital domain, the most power-consuming entities typically are processing cores. To reduce its power consumption, a processing core's supply voltage U_{DD} may be reduced to its bare minimum. The low voltage limiting factor for a supply voltage is a critical parameter for the processing delay τ, which is assumed to be shorter than clock cycle time T_{c} of the processing core. The slower the clock frequency f_{c}, the higher the tolerable delay τ and the lower the tolerable supply voltage U_{DD}. On the other hand, said clock frequency f_{c} must be high enough to perform a task in a given time frame. It can be observed that the processing performance requirements (in MIPS) usually vary over time. And typically, there is some regularity in the processing load over time (the “processing profile”). As there is an opportunity to save power by adapting operation clock frequency f_{c} to the bare minimum of what is desired for a certain time period to accomplish a task, a prediction of the clock speed is used. But clock frequency f_{c} prediction is everything but trivial, as the minimum clock frequency may depend on parameters such as e.g., on the operation mode of the system, the behavior of the user and the air interface condition (e.g., the signal strength of a received wireless signal or a wireless signal to be transmitted). Analytic prediction of clock frequency f_{c} is therefore a very difficult task. Hence, an algorithm that predicts the clock frequency of a complex system's processing core when being executed on said complex system is desirable.

US 2003/0 217 296 A1 describes a method and an apparatus for performing adaptive runtime power management in an information processing system employing a central processing unit (CPU) and an operating system (OS). A CPU cycle tracker (CCT) module monitors critical CPU signals and generates CPU performance data based on the critical CPU signals. An adaptive CPU throttler (THR) module uses the CPU performance data, along with a CPU percent idle value fed back from the operating system, to generate a CPU throttle control signal during predefined runtime segments of the CPU run time. The CPU throttle control signal links back to the CPU and adaptively adjusts CPU throttling and, therefore, power usage of the CPU during each of the runtime segments.

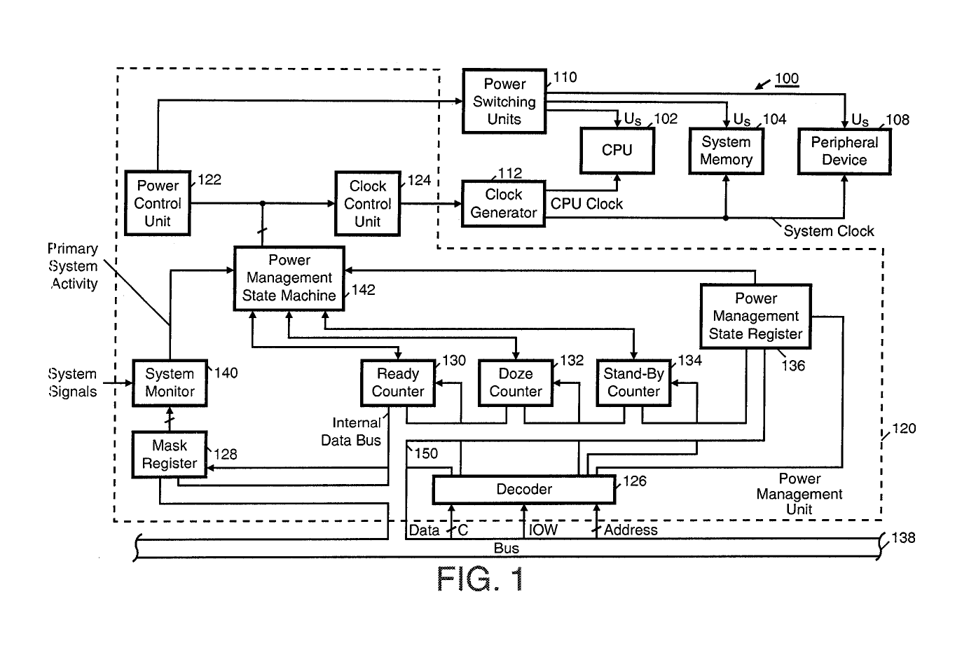

Referring now to the drawings, FIG. 1 shows a block diagram of a computer system 100 including a power management unit as known from prior-art document EP 0 666 527 A1, the disclosure of which illustrates the interconnections and interactions of the particular system components in an information processing system to which an embodiment of a power management unit as proposed can advantageously be applied. As depicted within the figure, said computer system 100 comprises a microprocessor as given by central processing unit 102 (CPU), which may e.g., be realized as a model 20486 microprocessor, a system memory 104 as well as a peripheral device 108. Furthermore, said computer system 100 comprises a power switching unit 110, a clock generator 112 and a power management unit 120. Clock generator 112 is used for generating a CPU clock signal and a system clock signal, and power switching unit 110 provides power to the various components of the computer system. Peripheral device 108 is illustrative of, for example, a variety of peripheral devices such as e.g., a keyboard, a printer, a modem, etc.

As can further be taken from FIG. 1, power management unit 120 comprises a power control unit 122 coupled to power switching unit 110 as well as a clock control unit 124 coupled to clock generator 112. Power management unit 120 further includes a decoder 126, a mask register 128, a ready counter 130, a doze counter 132, a stand-by counter 134, and a power management state register 136 coupled to a bus 138. Power management unit 120 also comprises a system monitor 140 coupled to mask register 128, and a power management state machine 142 coupled to power control unit 122 and clock control unit 124. Thereby, power management unit 120 is provided to regulate and minimize the power consumed by computer system 100. For the embodiment of FIG. 1, power switching unit 110 is controlled to selectively provide power to microprocessor 102, system memory 104, and peripheral device 108 depending upon the state of power management unit 120. Clock generator 112 may be similarly controlled such that the frequencies of the CPU clock signal and the system clock signal are varied depending upon the state of power management unit 120, as will be described in greater detail below.

FIG. 1 shows that power control unit 122 and clock control unit 124 control the power switching unit 110 and clock generator 112, respectively, depending upon the internal state of power management state machine 142. This power management state machine 142 may e.g., have a ready state, a doze state, a stand-by state, and a suspend state. During ready state, computer system 100 is considered full-on. All components of the computer system 100 are clocked at full speed and are powered-on. Power management state machine 142, may, for example, enter the ready state upon power-up of the computer system and upon reset. Power management state machine 142 may also enter the ready state when primary system activity is detected by system monitor 140 or in response to software writing of a ready state value into power management state register 136, as will be described below.

Transitions of power management state machine 142 from the ready state to the doze state if the computer system 100 is idle for a programmable amount of time are determined by ready counter 130 and system monitor 140. Power management state machine 142 can alternatively enter doze state via software writing of a doze state value into power management state register 136. During doze state, clock control unit 124 controls clock generator 112 such that the CPU clock signal is slowed down to a doze frequency, which may be a preprogrammed frequency. It is noted that during doze state, the system clock signal continues to be driven at maximum frequency and all components are powered-on.

Transitions of power management state machine 142 from the doze state to the stand-by state if the system is idle for a programmable amount of time without any primary activities occurring are determined by doze counter 132 and system monitor 140. The power management state machine 142 can alternatively enter the stand-by state via software writing to the power management state register 136. During the standby state, power control unit 122 causes the power switching unit 110 to remove power from peripheral device 108. In addition, during stand-by state, clock control unit 124 causes clock generator 112 to turn-off the CPU clock signal. The system clock signal thereby continues to be driven at maximum frequency.

Transitions of power management state machine 142 to the suspend state from the stand-by state if the system is idle for a programmable amount of time without any primary activities occurring are determined by stand-by counter 134 and system monitor 140. Thereby, power management state machine 142 may alternatively enter the suspend state via software writing of a suspend state value into power management state register 136. When power management state machine 142 is in the suspend state, power control unit 122 causes power switching unit 110 to remove power from peripheral device 108, and clock control unit 124 causes clock generator 112 to stop both the CPU clock signal and the system clock signal. Depending upon the system, the power control unit 122 may further cause power switching unit 110 to remove power from microprocessor 102 and system memory 104.

Decoder 126 is provided for decoding I/O write cycles executed on bus 138 by, for example, microprocessor 102. During such I/O write cycles, mask register 128, ready counter 130, doze counter 132, stand-by counter 134, and power management state register 136 may be loaded with various data that controls the power management unit 120. Data is provided to the mask register 128, ready counter 130, doze counter 132, stand-by counter 134, and power management state register 136 from bus 138 via internal data bus 150. It is noted that bus 138 may be coupled to microprocessor 102 directly or through a bus bridge.

System monitor 140 monitors the microprocessor 102, system memory 104, and other system components to determine whether certain primary activity is occurring. For example, system monitor 140 may monitor the CPU local bus to determine whether certain cycles are currently being executed. System monitor 140 may similarly monitor various interrupt signals to determine the initiation of primary system activity.

If system monitor 140 detects primary system activity, a signal labeled “Primary System Activity” is provided to power management state machine 142. Mask register 128 allows the programmer to mask certain activities that are normally detected by system monitor 140. For example, the system programmer may desire to prevent activities of a video monitor from being considered “primary activity” by system monitor 140. Accordingly, the mask register 128 may be set such that activities of the video monitor are ignored.

As stated previously, said power management state register 136 may be software programmed with one of several determined state values that controls the current state of power management state machine 142. A particular state value is written into power management state register 136 by executing an I/O write cycle on bus 138. Power management state register 136 thus accommodates Advanced Power Management (APM) software.

Ready counter 130, doze counter 132, and stand-by counter 134 may be configured within the system to protect against misbehaved software that does not operate according to, for example, the Advanced Power Management software standard. During operation, the ready counter 130 is loaded with a value that causes the ready counter 130 to count a period of time. As stated above, upon lapse of this programmable amount of time, power management state machine 142 makes the transition from the ready state to the doze state if primary system activity is not detected by system monitor 140. Similarly, doze counter 132 may be loaded with a value that causes the doze counter 132 to count for a programmable amount of time. Doze counter 132 controls the doze time-out period which causes power management state machine 142 to transition from doze state to stand-by state if primary system activity is not detected by system monitor 140. Finally, stand-by counter 134 may be loaded with a value that causes stand-by counter 134 to count a programmable amount of time.

The stand-by counter 134 controls the time-out period which causes the power management state machine 142 to transition from the stand-by state to the suspend state if primary activity is not detected by system monitor 140. The power management state machine 142 remains in suspend state until primary system activity is detected by system monitor 140 or until power management state register 136 is software written with a new state value. Primary system activity that causes power management state machine 142 to transition from the suspend state to the ready state may be, for example, the detection of a keyboard entry. It should further be noted that the ready counter 130, the doze counter 132, and the stand-by counter 134 may be reset when primary system activity is detected by system monitor 140.

In accordance with the power management unit 120 described above, Advanced Power Management software may be employed to control the state of the power management unit 120 via software I/O writes to power management state register 136. Power management unit 120 thereby protects against misbehaved software by providing ready counter 130, doze counter 132, and stand-by counter 134. If primary activity is undetected for an amount of time programmed within the various counters, power management state machine 142 successively enters several power reducing states during which the power to various components of the computer system may be removed and during which the frequencies of the CPU clock signal and the system clock signal may be reduced (or stopped). Thus, the power consumed by the computer system 100 is reduced even if software that is incognizant of the Advanced Power Management software standard is employed.

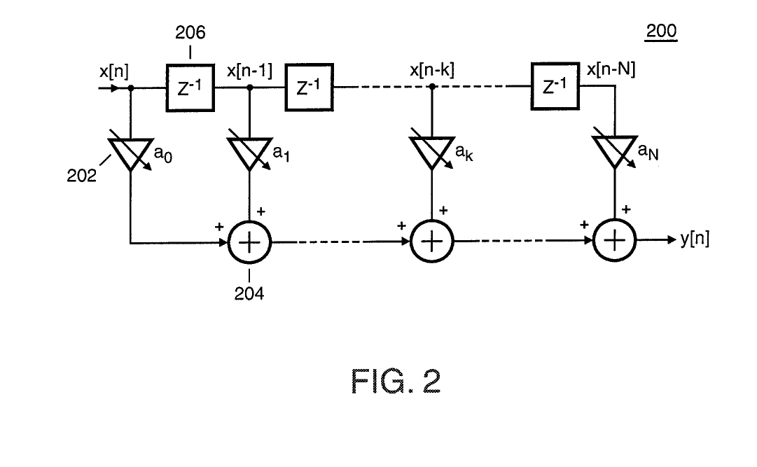

According to the first example embodiment, a linear adaptive finite impulse response (FIR) prediction filter 200 having a non-recursive filtering structure as depicted in FIG. 2 is proposed. Therein, delay elements 206 allow an observation of a given processing core's clock frequency f_{c} at discrete times tₙ=t₀+n·Δt (with nεIN₀) within a sliding observation window. As can be taken from this figure, a discrete time-domain signal x[n] representing this clock frequency at time slice n, in the following denoted as f_{c}ⁿ, is fed to the FIR filter's input port. The discrete time-domain output signal x[n−k] of the FIR filter's k-th delay element 206 (with kε {1, 2, . . . , N}) reflects the clock frequency at time slice (n−k), in the following denoted as f_{c}^{c-k}. The predicted clock frequency at a time slice (n+1) directly succeeding a current time slice n, in the following referred to as f_{c}ⁿ⁺¹ and represented by the discrete time-domain signal y[n] at the FIR filter's output port, is calculated as a weighted average of measured clock frequencies f_{c}ⁿ, f_{c}ⁿ⁻¹, f_{c}ⁿ⁻², . . . , f_{c}^{n-N} at time slices (n, n−1, n−2, . . . , n−N) preceding time slice (n+1) of the prediction, wherein these measured clock frequencies are represented by discrete time-domain signal x[n] at the FIR filter's input port and its time-delayed versions x[n−1], x[n−2], x[n−N], respectively. FIG. 2 further shows that signals x[n], x[n−1], x[n−2], . . . , x[n−N] are weighted with a set of filter coefficients {αₖ|k=0, 1, 2, . . . , N} that are specially adapted to minimize the clock frequency prediction error (e.g., the processing core's sleep duration). In frequency domain, the filtering procedure executed by prediction filter 200 can be expressed by the transfer function

$$\begin{matrix}H ( z ) := \frac{Y ( z )}{X ( z )} = {\sum }_{k = 0}^{N} {a}_{k} \cdot {z}^{- k} \\ = {a}_{0} + \frac{{\sum }_{k = 1}^{N} {a}_{k} \cdot {z}^{N - k}}{{z}^{N}} \\ = {a}_{0} + {a}_{1} \cdot \frac{{\prod }_{k = 1}^{N - 1} ( z - {z}_{c , k} )}{{\prod }_{k = 1}^{N} ( z - {z}_{p , k} )}\end{matrix} \qquad ( 4 a )$$

using

$$\begin{matrix}X ( z ) = Z \{ x [ n ] \} = {\sum }_{n = 0}^{+ ∞} x [ n ] \cdot {z}^{- n} [ \sqrt{W} ] ( n ∈ {IN}_{0} ) \\ and & ( 4 b ) \\ X ( z ) = Z \{ y [ n ] \} = {\sum }_{n = 0}^{+ ∞} y [ n ] \cdot {z}^{- n} [ \sqrt{W} ] ( n ∈ {IN}_{0} ) , & ( 4 c )\end{matrix}$$

with {z_{c,k}}_{k=1, . . . , N-1}, which are given by a function of filter coefficients {aₖ}_{k=0, . . . , N-1}, being the N−1 zeros of transfer function H(z), said zeros z_{c,k} having an order O_{c,k} in a range between 1 and N−1, and {z_{c,k}}_{k=1, . . . , N} with z_{c,N}=z_{c,N-1}= . . . =z_{c,1} being an N-fold pole at z=0 of said transfer function H(z). Thereby, H(z) can be obtained by applying a one-sided z transform to the impulse response

$$\begin{matrix}y [ n ] = x [ n ] * h [ n ] \\ = x [ n ] * {\sum }_{k = 0}^{N} {a}_{k} \cdot δ [ n - k ] \\ = {\sum }_{k = 0}^{N} {a}_{k} \cdot x [ n - k ] [ \sqrt{W} ] ( n ∈ {IN}_{0} ) ,\end{matrix} \qquad ( 5 a )$$

with

$$\begin{matrix}x [ n ] = {Z}^{- 1} \{ X ( z ) \} = \frac{1}{2 π \cdot j} \cdot {∮}_{C} X ( z ) \cdot {z}^{n - 1} d z [ \sqrt{W} ] \\ and & ( 5 b ) \\ y [ n ] = {Z}^{- 1} \{ Y ( z ) \} = \frac{1}{2 π \cdot j} \cdot {∮}_{C} Y ( z ) \cdot {z}^{n - 1} d z [ \sqrt{W} ] & ( 5 c )\end{matrix}$$

and

$$δ ( t ) := \{ \begin{matrix}0 & for t \neq 0 \\ ∞ & for t = 0\end{matrix} with {\int }_{- ∞}^{+ ∞} δ ( t ) d t := 1 \qquad ( 6 a \text{,} b )$$

being Dirac's delta function, and solving the hereby obtained equation, which is given in the form Y(z)=H(z)·X(z), for transfer function H(z). Therein, z:=e^{σ}+e^{j·2π·f} is a complex-valued substitution variable representing a real-valued frequency f, e^{σ} is a real-valued weighting factor for the magnitude of said substitution variable z,j:=\sqrt{−1} represents the imaginary unit and curve C is a closed integration path around z=0 for calculating above circulation integrals, which may e.g., be realized as a circle |z|=R having a radius R being greater than the respective convergence radii ρ_{X}, ρ_{Y}, and ρ_{H} of transfer functions X(z), Y(z) and H(z). In time domain, this filtering process can be expressed by the corresponding impulse response h[n] of said transfer function H(z):

$$h [ n ] = {Z}^{- 1} \{ H ( z ) \} = \frac{1}{2 π \cdot j} \cdot {∮}_{C} Y ( z ) \cdot {z}^{n - 1} d z = {\sum }_{k = 0}^{N} {a}_{k} \cdot δ [ n - k ] . \qquad ( 7 )$$

In equation (5a), discrete filter input signal x[n] can be identified as clock frequency f_{c}ⁿ at a current time slice n, discrete signals x[n−1], x[n−2], . . . , x[n−N] can be identified as N measured clock frequencies f_{c}ⁿ⁻¹, n_{c}ⁿ⁻², . . . , f_{c}^{n-N} at past time slices (n−1), (n−2), . . . , (n−N), and discrete filter output signal y[n] can be identified as the predicted clock frequency f_{c}ⁿ⁺¹ at time slice (n+1) directly succeeding the current time slice n and thus as a prediction for x[n+1].

For calculating the (N+1) filter coefficients {aₖ|k=0, 1, 2, . . . , N} of the non-recursive, adaptive filter, a similarity measure, such as e.g., the least mean square (LMS) optimization criterion or any other optimization criterion, may be used for minimizing the prediction error. In case of using an LMS optimization criterion, said prediction error is given in the form

$$\begin{matrix}{\overline{e}}^{2} ( \underline{a} ) := \frac{1}{N} \cdot {\sum }_{n = 1}^{N} {( x [ n ] - y [ n ] )}^{2} \\ = \frac{1}{N} \cdot {\sum }_{n = 1}^{N} {( x [ n ] - {\sum }_{k = 0}^{N} {a}_{k} \cdot x [ n - k ] )}^{2} ,\end{matrix} \qquad ( 8 )$$

wherein a:=[a₀, a₁, a₂, . . . , a_{N}]^{T}εIR^{N+1} denotes a coefficient vector whose elements are to be optimized by using necessary condition

$${\overline{e}}^{2} ( \underline{a} ) = Min ! ⇒ grad {\overline{e}}^{2} ( {\underline{a}}^{opt} ) = {[ \begin{matrix}\frac{\partial }{\partial {a}_{0}} , \frac{\partial }{\partial a 1} , … , \\ \frac{\partial }{\partial {a}_{N}}\end{matrix} ]}^{T} {\overline{e}}^{2} ( {\underline{a}}^{opt} ) {=}^{!} = \underline{0} \qquad ( 9 )$$

in conjunction with the two sufficient conditions

$$\begin{matrix}det {{H}_{\underline{\_}}}_{{\overline{e}}^{2}} ( {\underline{a}}^{opt} ) > 0 \\ and & ( 10 a ) \\ {⋀}_{k = 0}^{N} {λ}_{k} ( {{H}_{\underline{\_}}}_{{\overline{e}}^{2}} ( {\underline{a}}^{opt} ) ) > 0. & ( 10 b )\end{matrix}$$

### Thereby,

$${H}_{\underline{\_}} {\overline{e}}^{2} ( \underline{a} ) := {( \frac{{\partial }^{2}}{\partial {a}_{k} \partial {a}_{1}} {\overline{e}}^{2} ( \underline{a} ) )}_{k , l ∈ \{ 0 , 1 , … , N \}}$$

$$with {{H}_{\underline{\_}}}_{{\overline{e}}^{2}} ( \underline{a} ) ∈ {IR}^{( N + 1 ) \times ( N + 1 )}$$

is the Hesse matrix of said mean square error ē²(a), a^{opt}; =└â⁰, â¹, . . . , â^{N}┘^{T} denotes an optimized parameter vector whose elements are given by a set of (N+1) optimized parameters â₀, â₁, . . . , â_{N}, and the argument of multivariate prediction error function ē²(a) as described above is given by coefficient vector a. In equation (10b), {λk(H_{ē}2(a^{opt}))}_{k=0, 1, . . . , N} denote the eigenvalues of Hesse matrix H_{ē}2(a^{opt}), which can be calculated by solving characteristic equation

$${det ( {{H}_{\underline{\_}}}_{{\overline{e}}^{2}} ( {\underline{a}}^{opt} ) - {λ}_{k} ( {{H}_{\underline{\_}}}_{{\overline{e}}^{2}} ( {\underline{a}}^{opt} ) ) \cdot {I}_{\underline{\_}} )}^{!} = 0 \qquad ( 12 )$$

for unknown variables λₖ(kε {0, 1, . . . , N}), and

$$\begin{matrix}{I}_{\underline{\_}} := diag {( 1 , 1 , … , 1 )}_{( N + 1 ) matrix elements} = {( {δ}_{kl} )}_{k , l ∈ \{ 0 , 1 , … , N \}} , \\ with & ( 13 a ) \\ {δ}_{ij} := \{ \begin{matrix}1 , & for k = 1 \\ 0 , & for k \neq 1\end{matrix} for k , l ∈ \{ 0 , 1 , … , N \} & ( 13 b )\end{matrix}$$

being the Kronecker delta, denotes the (N+1)×(N+1)-dimensional identity matrix.
The components of optimized parameter vector

$${\underline{a}}^{opt} := {[ {\hat{a}}_{0} , {\hat{a}}_{1} , … , {\hat{a}}_{N} ]}^{T} = arg {min}_{\underline{a}} {\overline{e}}^{2} ( \underline{a} )$$

are then substituted into the right side of equation (5a) instead of filter coefficients a₀, a₁, a₂, . . . , a_{N} in order to make the prediction as good as possible.

In this context, it should further be noted that measures may be applied to avoid clock under-run (which means the case where a task is not completed in time). This can be done, for example, by applying a clock frequency margin Δf_{c}, or through a “panic mode”, where a higher clock frequency is applied in case that the timing gets overcritical.

The implementation of this adaptive FIR filter may e.g., be done in such a way that a track record of selected clock frequency values is stored in a random access memory (RAM) of a component comprising the processing subsystem. By means of a shared memory concept, either the same or another processing entity could run the filter algorithm to calculate the optimum clock frequency f_{c}ⁿ⁺¹ for the time slice (n+1) which directly succeeds a current time slice n. As a digital signal processor is especially suited for filter implementations and as the digital signal processor can operate in a very power efficient mode, an embodiment may use a digital signal processor for this task.

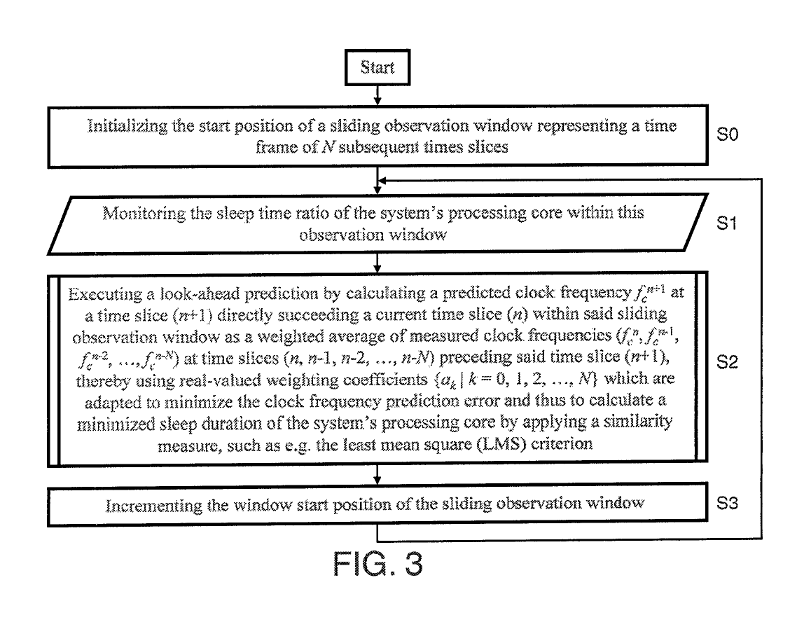

In FIG. 3, a flowchart which illustrates the proposed method according to an example embodiment is shown in form of an endless loop. After having initialized (S0) the start position of a sliding observation window which represents a time frame of N subsequent time slices, a look-ahead prediction for predicting the clock frequency f_{c} of a complex low-power integrated system's processing core whose performance and power consumption are to be controlled is executed (S2) based on the monitored (S1) sleep time ratio of said processing core within this observation window. As indicated above, this prediction may e.g., be executed by calculating a predicted clock frequency f_{c}ⁿ⁺¹ at a time slice (n+1) directly succeeding a current time slice (n) within this observation window as a weighted average of measured clock frequencies f_{c}ⁿ, f_{c}ⁿ⁻¹, f_{c}ⁿ⁻², . . . , f_{c}^{n-N} at time slices (n, n−1, n−2, . . . , n−N) preceding said time slice (n+1), thereby using a set of real-valued weighting coefficients {aₖ|k=0, 1, . . . , N} which are specially adapted to minimize the clock frequency prediction error and thus to calculate a minimized sleep duration of the system's processing core by applying a similarity measure, such as e.g., given by the least mean square criterion. After that, the window start position of the sliding observation window is incremented (S3), and the procedure is continued again with step S1.

### EXAMPLE APPLICATIONS OF EMBODIMENTS

Embodiments can be advantageously applied to multi-tasking and multi-threading systems with varying processing loads. Aside from being applied for clock rate based power management tasks which arise in the scope of personal computers, workstations, notebooks, laptops, organizers, personal digital assistants, pocket calculators, etc., embodiments can also be applied to high-end cellular mobile terminals where baseband processing units and application processing units are implemented by a multi-processor concept with, for example, up to ten processors which have to be controlled in a coordinated way. Moreover, embodiments may be used for power management of any other wireless or wire-bound, battery- or means-powered computing, communication and/or information processing devices. While the present disclosure has been illustrated and described in detail in the drawings and in the foregoing description, such illustration and description are to be considered illustrative or exemplary and not restrictive, which means that the disclosure is not limited to the specific disclosed embodiments. Other variations to the disclosed embodiments can be understood and effected by those skilled in the art, from a study of the drawings, the disclosure and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures can not be used to advantage. A computer program may be stored/distributed on a suitable medium, such as e.g., an optical storage medium or a solid-state medium supplied together with or as part of other hardware, but may also be distributed in other forms, such as e.g., via the Internet or other wired or wireless telecommunication systems. Any reference signs in the claims should not be construed as limiting.

Some embodiments may take the form of computer program products. For example, according to one embodiment there is provided a computer readable medium comprising a computer program adapted to perform one or more of the methods described above. The medium may be a physical storage medium such as for example a Read Only Memory (ROM) chip, or a disk such as a Digital Versatile Disk (DVD-ROM), Compact Disk (CD-ROM), a hard disk, a memory, a network, or a portable media article to be read by an appropriate drive or via an appropriate connection, including as encoded in one or more barcodes or other related codes stored on one or more such computer-readable mediums and being readable by an appropriate reader device.

Furthermore, in some embodiments, some or all of the systems and/or modules may be implemented or provided in other manners, such as at least partially in firmware and/or hardware, including, but not limited to, one or more application-specific integrated circuits (ASICs), discrete circuitry, standard integrated circuits, controllers (e.g., by executing appropriate instructions, and including microcontrollers and/or embedded controllers), field-programmable gate arrays (FPGAs), complex programmable logic devices (CPLDs), etc., as well as devices that employ RFID technology. In some embodiments, some of the modules or controllers separately described herein may be combined, split into further modules and/or split and recombined in various manners.

The systems, modules and data structures may also be transmitted as generated data signals (e.g., as part of a carrier wave) on a variety of computer-readable transmission mediums, including wireless-based and wired/cable-based mediums.

The various embodiments described above can be combined to provide further embodiments. For example, embodiments of FIGS. 2 and 3 may be incorporated into the embodiment of FIG. 1. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A power management unit comprising:
an input configured to receive a signal predictive of a regularity of a system processing core clock frequency based on a processing core sleep time ratio in a sliding observation window; and
a controller configured to generate signals to control processing core performance and power consumption based on the signal indicative of the regularity of the system processing core clock frequency.

2. The power management unit of claim 1 wherein the controller is configured to generate the signals to control processing core performance and power consumption to reduce performance and power consumption to levels consistent with a prediction of levels to perform outstanding computational operations and software tasks just in time for further processing.

3. The power management unit of claim 1 wherein the controller is configured to generate the signals to control processing core performance and power consumption without using information regarding a scheduled processing load.

4. The power management unit of claim 1, further comprising an adaptive prediction filter coupled to the input and configured to generate the signal predictive of a regularity of a processing core clock frequency.

5. The power management unit of claim 4 wherein the sliding observation window comprises a number N of time slices and the adaptive prediction filter comprises a linear finite impulse response filter with (N+1) filter coefficients.

6. The power management unit of claim 1, further comprising an adaptive prediction filter coupled to the input and configured to provide amplification, summation and delay elements to calculate a predicted clock frequency (f_{c}ⁿ⁺¹) at a time slice (n+1) succeeding a current time slice (n) within said sliding observation window as a weighted average of measured f_{c}ⁿ, f_{c}ⁿ⁻¹, f_{c}ⁿ⁻², . . . , f_{c}^{n-N}) clock frequencies) at time slices (n, n−2, . . . , n−N) preceding said time slice (n+1), thereby using real-valued weighting coefficients {aₖ|k=0, 1, 2, . . . , N} which are adapted to minimize a clock frequency prediction error.

7. The power management unit of claim 6, comprising a digital signal processor which implements said adaptive prediction filter, said digital signal processor being adapted to calculate a minimized frequency prediction error and thus to calculate a minimized sleep duration of the processing core by applying a similarity measure.

8. The power management unit of claim 7 wherein said similarity measure is given by a least mean square optimization criterion.

9. The power management unit of claim 1 wherein the system is a complex low-power integrated system.

10. The power management unit of claim 9 wherein the system is at least one of a high-end cellular mobile terminal, a workstation, a notebook, a laptop, an organizer, a personal digital assistant, and a pocket calculator.

11. A complex low-power integrated system, comprising:
a processing core; and
a power management unit configured to generate signals to control performance and power consumption of the processing core based on an indication of a processing core sleep time ratio in a sliding observation window having a number N of time slices.

12. The complex low-power integrated system of claim 11, further comprising an adaptive prediction filter configured to generate a signal predictive of a regularity of the processing core clock frequency based on the indication of the processing core sleep time ratio, wherein the power management unit is configured to generate the signals to control performance and power consumption based on the signal predictive of the regularity of the processing core clock frequency.

13. The complex low-power integrated system of claim 12 wherein the adaptive prediction filter comprises a linear finite impulse response filter with (N+1) filter coefficients.

14. The complex low-power integrated system of claim 12 wherein the adaptive prediction filter comprises amplification, summation and delay elements configured to calculate a predicted clock frequency (f_{c}ⁿ⁺¹) at a time slice (n+1) succeeding a current time slice (n) within said sliding observation window as a weighted average of measured clock frequencies f_{c}ⁿ, f_{c}ⁿ⁻¹, f_{c}ⁿ⁻², . . . , f_{c}^{n-N1}) at time slices (n, n−1, n−2, . . . , n−N) preceding said time slice (n+1), thereby using real-valued weighting coefficients {aₖ|k=0, 1, 2, . . . , N} which are adapted to minimize a clock frequency prediction error.

15. The complex low-power integrated system according to claim 12 comprising a digital signal processor which implements said adaptive prediction filter, said digital signal processor being configured to calculate a minimized frequency prediction error and a minimized sleep duration of the processing core by applying a similarity measure.

16. The complex low-power integrated system according to claim 15 wherein said similarity measure is given by a least mean square optimization criterion.

17. A method, comprising:
monitoring a sleep time ratio of a processing core in a sliding observation window having a number N of time slices;
predicting a regularity of a processing core clock frequency based on the monitoring; and
generating signals to control processing core performance and power consumption based on the predicting.

18. The method of claim 17 wherein the predicting comprises applying an adaptive prediction filtering algorithm based upon a filtering model using a linear finite impulse response filter with (N+1) filter coefficients.

19. The method according to claim 18 wherein the adaptive prediction filtering algorithm comprises using amplification, summation and delay operations to calculate a predicted clock frequency (f_{c}ⁿ⁺¹) at a time slice (n+1) succeeding a current time slice (n) within said sliding observation window as a weighted average of measured clock frequencies (f_{c}ⁿ, f_{c}ⁿ⁻¹, f_{c}ⁿ⁻², . . . , f_{c}^{n-N1}) at time slices (n, n−1, n−2, . . . , n−N) preceding said time slice (n+1), thereby using real-valued weighting coefficients {aₖ|k=0, 1, 2, . . . , N} which are adapted to minimize a clock frequency prediction error.

20. The method of claim 19, comprising calculating a minimized frequency prediction error and thus calculating a minimized sleep duration of the processing core by applying a similarity measure.

21. The method of claim 20 wherein said similarity measure is given by a least mean square optimization criterion.

22. A computer readable memory medium whose contents cause at least one processor to perform a method, the method comprising:
monitoring a sleep time ratio of a processing core in a sliding observation window having a number N of time slices;
predicting a regularity of a processing core clock frequency based on the monitoring; and
generating signals to control processing core performance and power consumption based on the predicting.

23. The computer readable memory medium of claim 22 wherein the predicting comprises applying an adaptive prediction filtering algorithm based upon a filtering model using a linear finite impulse response filter with (N+1) filter coefficients.

24. The computer readable memory medium of claim 23 wherein the adaptive prediction filtering algorithm provides amplification, summation and delay operations to calculate a predicted clock frequency (f_{c}ⁿ⁺¹) at a time slice (n+1) succeeding a current time slice (n) within said sliding observation window as a weighted average of measured clock frequencies (f_{c}ⁿ, f_{c}ⁿ⁻¹, f_{c}ⁿ⁻², . . . , f_{c}^{n-N}) at time slices (n, n−1, n−2, . . . , n−N) preceding said time slice (n+1), thereby using real-valued weighting coefficients {aₖ|k=0, 1, 2, . . . , N} which are adapted to minimize a clock frequency prediction error.

25. The computer readable memory medium of claim 24 wherein the method comprises calculating a minimized frequency prediction error and thus calculating a minimized sleep duration of the processing core by applying a similarity measure.

26. The computer readable memory medium of claim 25 wherein said similarity measure is given by a least mean square optimization criterion.

27. A power management unit, comprising:
means for monitoring a sleep time ratio of a processing core in a sliding observation window having a number N of time slices;
means for predicting a regularity of a processing core clock frequency based on the monitoring; and
means for generating signals to control processing core performance and power consumption based on the predicting.

28. The power management unit of claim 27 wherein the means for predicting comprises a linear finite impulse response filter with (N+1) filter coefficients.

29. The power management unit of claim 27 wherein the means for predicting is configured to use amplification, summation and delay operations to calculate a predicted clock frequency (f_{c}ⁿ⁺¹) at a time slice (n+1) succeeding a current time slice (n) within said sliding observation window as a weighted average of measured clock frequencies (f_{c}ⁿ, f_{c}ⁿ⁻¹, f_{c}ⁿ⁻², . . . , f_{c}^{n-N1}) at time slices (n, n−1, n−2, . . . , n−N) preceding said time slice (n+1), thereby using real-valued weighting coefficients {aₖ|k=0, 1, 2, . . . , N} which are adapted to minimize a clock frequency prediction error.

30. The power management unit of claim 29 wherein the means for generating signals to control processing core performance and power consumption is configured to calculate a minimized sleep duration of the processing core by applying a similarity measure.

31. The power management unit of claim 30 wherein said similarity measure is given by a least mean square optimization criterion.
